(19) United States
(12) Patent Application Publication
(10) Pub. No.: US 2022/0081788 A1
(43) Pub. Date: Mar. 17, 2022

(54) General method for the synthesis of FeCoNiCu-based high-entropy alloy and their application for electrocatalytic water splitting

(71) Applicant: Jiangnan University, Wuxi (CN)

(72) Inventors: Han Zhu, Wuxi (CN); Songge Zhang, Wuxi (CN); Jian Cai, Wuxi (CN); Huilin Li, Wuxi (CN); Mingliang Du, Wuxi (CN)

(21) Appl. No.: 17/532,219

(22) Filed: Nov. 22, 2021

Related U.S. Application Data
(63) Continuation of application No. PCT/CN2019/129204, filed on Dec. 27, 2019.

(51) Int. Cl. C25B 11/054; B22F 9/10; C25B 1/04; C25B 11/065; C25B 11/089

(52) U.S. Cl. CPC C25B 11/054; B22F 9/10; C25B 11/089; C25B 11/065; C25B 1/04

(57) ABSTRACT

The disclosure herein discloses a general method for the synthesis of FeCoNiCu-based high-entropy alloy and their application for electrocatalytic water splitting, belonging to the technical field of preparation of composite materials. The catalytic material for electrolysis of water includes a reaction active material and a support. The reaction active material is FeCoNiCu-based high-entropy alloy nanoparticles such as FeCoNiCuSn, FeCoNiCuMn, FeCoNiCuV or the like. The support is a carbon nanofiber material prepared by electrospinning. The catalytic material for electrolysis of water prepared in the disclosure herein has a high specific surface area, which facilitates diffusion of the electrolyte and desorption of gas. By using the catalytic material for electrolysis of water, hydrogen and oxygen can be produced under alkaline conditions, and the hydrogen production rate under high voltage is much higher than that of a 20% Pt/C electrode. Meanwhile, the carbon nanofibers can effectively protect the high-entropy alloy nanoparticles from erosion of the electrolyte, and endow the catalytic material with good stability.

### TECHNICAL FIELD

The disclosure herein relates to a general method for the synthesis of FeCoNiCu-based high-entropy alloy and their application for electrocatalytic water splitting, belonging to the technical field of preparation of composite materials.

### BACKGROUND

Energy is an important material basis for human survival and development of civilization. The depletion of fossil fuels, such as oil, coal and natural gas, has forced people to seek for a new renewable energy source with abundant reserves. Hydrogen is considered to be one of the most promising green energies in the 21st century due to its high combustion heat, non-polluting combustion products and recyclability. Therefore, the development of hydrogen energy has become one of the research hotspots in the field of new energy. Although hydrogen is the most common element in nature (making up about 75% of the mass of the universe), it is mainly stored in water in the form of a compound and cannot be used directly. Therefore, the realization of a cheap, efficient and large-scale pathway for hydrogen production is the precondition for the development of hydrogen economy.

Hydrogen production from fossil fuels, hydrogen production from biomass, photocatalytic hydrogen production and hydrogen production by electrolysis of water are currently the main methods of hydrogen production. Among them, electrolysis of water is an important means to realize industrialized and cheap production of hydrogen, produced H₂ and O₂ have high purity, and the conversion rate is close to 100%. However, the electrocatalytic process requires high energy consumption, so a catalyst is needed to reduce cathodic overpotential. More importantly, the electrode materials for electrocatalytic water splitting in traditional industries mainly rely on the noble metal Pt and oxides thereof that have high price, small specific surface area and poor stability, which limits the industrialization process of electrocatalytic hydrogen production. Therefore, research and development of electrode materials for electrocatalytic water splitting with low cost, high efficiency and high stability are of great economic value and social significance.

In 2018, Hu Liangbing et al. from the University of Maryland proposed a five- to eight-element nanoscale high-entropy alloy prepared by carbothermal shock. This alloy maintains a single solid solution structure instead of being separated into different intermetallic phases. In high-entropy alloys, the large number of elements will maximize the configuration entropy, such that the alloys have unusual properties. However, the carbothermal shock method requires harsh conditions and is difficult for mass production, so finding a simple preparation method of nanoscale high-entropy alloys is one of the challenges at present.

Carbon nanofibers (CNFs) prepared by electrospinning have the advantages of high efficiency and stability, large specific surface area, high porosity, good adsorbability, etc. Compared with the traditional method, using the carbon nanofibers as a reaction vessel and support, alloy nanoparticles with good dispersion, uniform particle size and single phase can be prepared and can be used as a self-supporting catalytic electrode material for electrolysis of water.

### SUMMARY

In order to solve the problems of high cost, low catalytic activity, poor stability and poor conductivity of the existing catalytic material for electrolysis of water, the disclosure herein provides a FeCoNiCu-based high-entropy alloy catalytic material for electrolysis of water and a preparation method thereof. In the disclosure herein, electrospinning and high-temperature gas-assisted carbonization are used to prepare the carbon nanofiber-supported FeCoNiCu-based high-entropy alloy nanoparticles. The method is low in cost, and the obtained composite material has high hydrogen evolution and oxygen evolution activities under alkaline conditions, and has good stability.

A first objective of the disclosure herein is to provide a preparation method of a FeCoNiCu-based high-entropy alloy catalytic material for electrolysis of water (FeCoNiCuX HEA/CNFs, X=Sn, Mn, V, HEA=High entropy alloy). The preparation method includes the following steps:

(1) preparation of nanofibers containing four elements of Fe, Co, Ni and Cu and one or more elements of Sn, Mn and V: adding precursors of the elements of Fe, Co, Ni and Cu, a precursor (precursors) of one or more elements of the Sn, Mn and V, and a polymer material into a carbon fiber precursor solution, and stirring the mixture uniformly to obtain a mixed solution; and then spinning the mixed solution by electrospinning to obtain the nanofibers containing four elements of the Fe, Co, Ni and Cu and one or more elements of the Sn, Mn and V; and

(2) preparation of carbon nanofibers-supported FeCoNiCu-based high-entropy alloy nanoparticle electrocatalytic material: calcining the nanofibers prepared in step (1), and carrying out preoxidation by raising the temperature to 230° C.-280° C. at a heating rate of 10-30° C./min and holding the temperature for 1-3 hours in an air atmosphere; after the completion of the holding, carrying out carbonization by raising the temperature to 800-1200° C. at a rate of 10-30° C./min in an inert gas atmosphere and holding the temperature for 1-3 hours; and after the completion of the holding, cooling the nanofibers to room temperature under the protection of the inert gas to obtain the carbon nanofibers-supported FeCoNiCu-based high-entropy alloy nanoparticle catalytic material.

In an implementation of the disclosure herein, the precursor of the element Fe in step (1) is one or more of ferric chloride, ferric acetate, ferric nitrate and ferric acetylacetonate.

In an implementation of the disclosure herein, the precursor of the element Co in step (1) is one or more of cobalt chloride, cobalt acetate, cobalt nitrate and cobalt acetylacetonate.

In an implementation of the disclosure herein, the precursor of the element Ni in step (1) is one or more of nickel chloride, nickel acetate, nickel nitrate and nickel acetylacetonate.

In an implementation of the disclosure herein, the precursor of the element Cu in step (1) is one or more of cupric chloride, cupric acetate, cupric nitrate and cupric acetylacetonate.

In an implementation of the disclosure herein, the precursor of the element Sn in step (1) is one or both of stannic chloride and stannic tetraacetate.

In an implementation of the disclosure herein, the precursor of the element Mn in step (1) is one or more of manganese chloride and manganese acetate.

In an implementation of the disclosure herein, the precursor of the element V in step (1) is one or more of vanadium chloride, vanadium acetylacetonate and vanadyl acetylacetonate.

In an implementation of the disclosure herein, an addition amount of the precursor of the element Fe in step (1) is 0.1-0.5 mmol.

In an implementation of the disclosure herein, an addition amount of the precursor of the element Co in step (1) is 0.1-0.5 mmol.

In an implementation of the disclosure herein, an addition amount of the precursor of the element Ni in step (1) is 0.1-0.5 mmol.

In an implementation of the disclosure herein, an addition amount of the precursor of the element Cu in step (1) is 0.1-0.5 mmol.

In an implementation of the disclosure herein, an addition amount of the precursor of the element Sn in step (1) is 0.1-0.5 mmol.

In an implementation of the disclosure herein, an addition amount of the precursor of the element Mn in step (1) is 0.1-0.5 mmol.

In an implementation of the disclosure herein, an addition amount of the precursor of the element V in step (1) is 0.1-0.5 mmol.

In an implementation of the disclosure herein, a content of each of the four elements of the Fe, Co, Ni and Cu in the nanofibers in step (1) is 5-35 wt %, and a total content of the one or more elements of the Sn, Mn and V is 5-35 wt %.

In an implementation of the disclosure herein, a mole ratio of Fe:Co:Ni:Cu:one or more elements of the Sn, Mn and V in the nanofibers in step (1) is (1-2):(1-4):(1-4):(1-4):(1-4).

In an implementation of the disclosure herein, a mole ratio of Fe:Co:Ni:Cu:one or more elements of the Sn, Mn and V in the nanofibers in step (1) is 1:1:1:1:1.

In an implementation of the disclosure herein, the carbon fiber precursor in step (1) is any one of polyacrylonitrile, polyvinylpyrrolidone and polyvinyl alcohol, or a mixture of polyacrylonitrile and polyvinylpyrrolidone, and a mass ratio of the polyacrylonitrile to the polyvinylpyrrolidone in the mixture is 1:(0.5-2).

In an implementation of the disclosure herein, when the carbon fiber precursor is the polyacrylonitrile, a solvent in the carbon fiber precursor solution is N,N-dimethylformamide or dimethyl sulfoxide; when the carbon fiber precursor is the polyvinylpyrrolidone, a solvent in the carbon fiber precursor solution is N,N-dimethylformamide, dimethyl sulfoxide, water or ethanol; and when the carbon fiber precursor is the polyvinyl alcohol, a solvent in the carbon fiber precursor solution is water.

In an implementation of the disclosure herein, the polymer material added in step (1) is dicyandiamide.

In an implementation of the disclosure herein, conditions of the electrospinning in step (1) are as follows: a spinning voltage is controlled to 10-30 kV, a distance between a receiver and a needle is 15-30 cm, and a solution flow rate is 0.05-0.30 mL/min.

In an implementation of the disclosure herein, an amount of the FeCoNiCu-based high-entropy alloy nanoparticles supported on the carbon nanofibers in step (2) is 2-30 wt %.

In an implementation of the disclosure herein, the FeCoNiCu-based high-entropy alloy nanoparticles in step (2) have a size of 5-100 nm.

In an implementation of the disclosure herein, the carbon nanofiber material in step (2) have a diameter of 50-600 nm.

In an implementation of the disclosure herein, the calcining in step (2) includes putting the nanofibers prepared in step (1) into a corundum boat and calcining the nanofibers after placing the corundum boat in the middle of a tube furnace.

In an implementation of the disclosure herein, the inert gas in step (2) is one or both of argon and nitrogen.

In an implementation of the disclosure herein, the heating rate in step (2) is one or more of 10° C./min, 15° C./min, 20° C./min, 25° C./min and 30° C./min.

In an implementation of the disclosure herein, the heating rate in step (2) is 20° C./min.

In an implementation of the disclosure herein, a temperature of the carbonization in step (2) is 1000° C.

A second objective of the disclosure herein is to provide a FeCoNiCu-based high-entropy alloy catalytic material for electrolysis of water obtained by the above preparation method.

A third objective of the disclosure herein is to provide a method of hydrogen production by electrolysis of water. The method uses the above FeCoNiCu-based high-entropy alloy catalytic material for electrolysis of water.

The disclosure herein has the following beneficial effects:

(1) According to the FeCoNiCu-based high-entropy alloy prepared in the disclosure herein, multiple metal elements form a single solid solution. No longer limited by the properties of a single element and the position of a single element in the electrocatalysis volcano plot, the catalyst with high activity is formed.

(2) Using one-dimensional carbon nanofibers as the reaction vessel for induced growth of FeCoNiCu-based high-entropy alloy nanoparticles, a method of growing a high-entropy alloy using a one-dimensional carbon material is developed. Meanwhile, there exists strong electronic coupling between the one-dimensional carbon nanofiber material prepared by electrospinning and the high-entropy alloy nanoparticles, thereby further improving the catalytic activity.

(3) The FeCoNiCu-based high-entropy alloy catalytic material for electrolysis of water prepared in the disclosure herein has a high active area, which facilitates diffusion of the electrolyte. Besides, the carbon nanofibers can effectively protect the high-entropy alloy nanoparticles from erosion of the electrolyte, and endow the catalytic material with good stability. Meanwhile, the catalytic material prepared in the disclosure herein can be directly used as an electrode, and does not need to be coated to the electrode surface.

### BRIEF DESCRIPTION OF FIGURES

FIG. 1A shows a field emission scanning electron microscope (SEM) image of the FeCoNiCuSn−1/CNFs in Example 1. FIG. 1B shows a transmission electron microscope (TEM) image of the FeCoNiCuSn−1/CNFs in Example 1. FIG. 1C shows a percentage graph of elements in the FeCoNiCuSn−1/CNFs in Example 1. FIG. 1D shows STEM-EDS mapping element distribution images of the FeCoNiCuSn−1/CNFs nanoparticles in Example 1.

FIG. 2 shows an X-ray diffractogram of the FeCoNiCuSn−1/CNFs in Example 1.

FIG. 3A shows a hydrogen evolution area activity curve of the FeCoNiCuSn−1/CNFs in Example 1 and a 20% Pt/C electrode. FIG. 3B shows a hydrogen evolution mass activity curve of the FeCoNiCuSn−1/CNFs in Example 1 and the 20% Pt/C electrode. FIG. 3C shows an oxygen evolution area activity curve of the FeCoNiCuSn−1/CNFs in Example 1 and an IrO₂ electrode. FIG. 3D shows a oxygen evolution mass activity curve of the FeCoNiCuSn−1/CNFs in Example 1 and the IrO₂ electrode.

FIG. 4 shows STEM-EDS mapping images of MnZnNiCuSn/CNFs in Comparative Example 1.

FIG. 5 shows an X-ray diffractogram of FeCoNiCuSn-a/CNFs prepared at a heating rate of 5° C./min in Comparative Example 2.

FIG. 6A shows a hydrogen evolution area activity curve of the FeCoNiCuSn−2/CNFs in Comparative Example 3. FIG. 6B shows an oxygen evolution area activity curve of the FeCoNiCuSn−2/CNFs in Comparative Example 3.

FIG. 7A shows a hydrogen evolution area activity curve of the FeCoNiCuSn−3/CNFs in Comparative Example 4. FIG. 7B shows a oxygen evolution area activity curve of the FeCoNiCuSn−3/CNFs in Comparative Example 4.

### DETAILED DESCRIPTION

In order to better understand the disclosure herein, the contents of the disclosure herein will be further illustrated below in combination with the examples. However, the contents of the disclosure herein are not limited to the examples given below.

### Example 1

Preparation of FeCoNiCuSn HEA/CNFs Catalytic Material for Electrolysis of Water

(1) 0.1 mmol of ferric chloride, 0.1 mmol of cobalt chloride, 0.1 mmol of nickel chloride, 0.1 mmol of cupric chloride, 0.1 mmol of stannic chloride and 0.2 g of dicyandiamide were added to 30 g of polyacrylonitrile/N,N-dimethylformamide solution with a mass fraction of 18 wt %, the mixture was magnetically stirred uniformly, and then the solution was spun by electrospinning to obtain mixed nanofibers. A spinning voltage was controlled to 15 kV, a distance between a receiver and a spinning needle was 15 cm, and a solution flow rate was 0.05 mL/min.

(2) 0.5 g of the mixed nanofibers prepared in the step (1) was put into a corundum boat, and the corundum boat was placed in the middle of a tube furnace. The temperature was raised to 230° C. at a heating rate of 20° C./min and held for 3 hours in an air atmosphere. After the completion of the holding, carbonization was carried out by raising the temperature to 1000° C. at a rate of 20° C./min in an argon atmosphere and holding the temperature at 1000° C. for 3 hours. After the completion of the holding, the nanofibers were cooled to room temperature under the protection of the argon to obtain the catalytic material FeCoNiCuSn HEA/CNFs, recorded as FeCoNiCuSn−1/CNFs.

Morphology Characterization

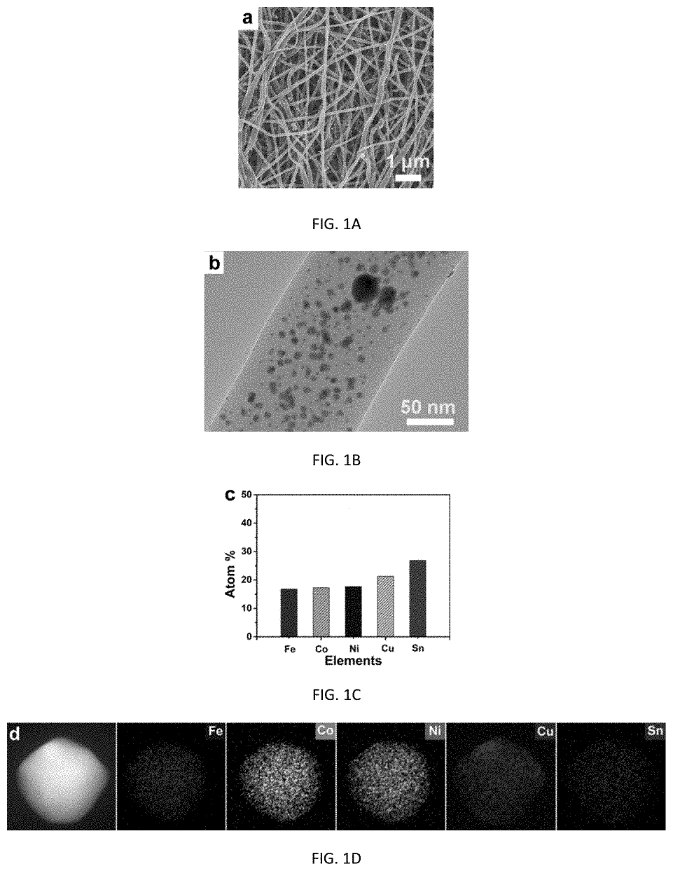

A SEM image was taken on the obtained FeCoNiCuSn HEA/CNFs catalytic material for electrolysis of water. FIG. 1A shows a field emission SEM image of the FeCoNiCuSn−1/CNFs. As can be seen from FIG. 1A, the FeCoNiCuSn HEA nanoparticles are uniformly dispersed on the carbon nanofibers (CNFs) having a diameter of about 200 nm, forming a unique three-dimensional network structure. FIG. 1B shows a TEM image of the FeCoNiCuSn−1/CNFs. As can be seen from FIG. 1B, the FeCoNiCuSn HEA nanoparticles have a size of 20-50 nm. FIG. 1C shows a percentage graph of five elements in the FeCoNiCuSn−1/CNFs. The percentages of elements were measured by inductively coupled plasma emission spectroscopy. As can be seen from FIG. 1C, atomic percentages of Fe, Co, Ni, Cu and Sn are respectively between 5%-35%, which meets the standards for high-entropy alloys. FIG. 1D shows element distribution images of the FeCoNiCuSn−1/CNFs. FIG. 1D shows that Fe, Co, Ni, Cu and Sn are uniformly distributed in the whole particle, confirming the formation of the high-entropy alloy nanoparticles.

Microstructure Characterization

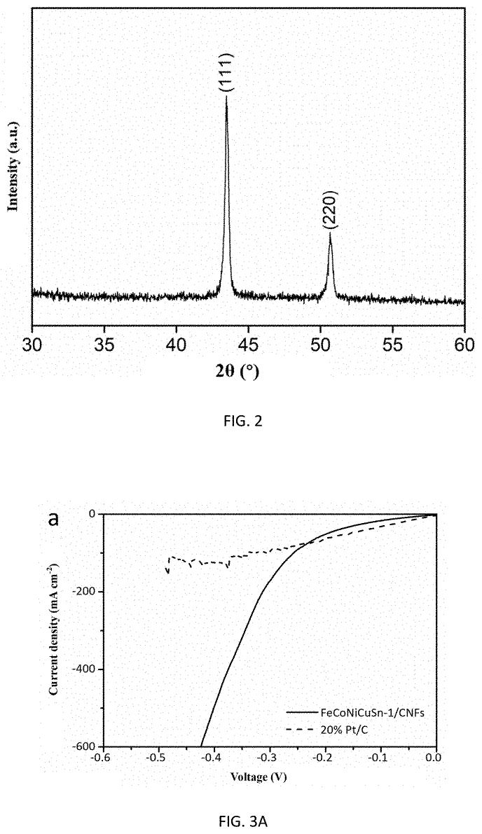

FIG. 2 shows an X-ray diffractogram (XRD) of the FeCoNiCuSn−1/CNFs. As can be seen from FIG. 2, peaks of the FeCoNiCuSn−1/CNFs at 43.5° and 50.7° respectively correspond to the (111) and (220) planes of the FeCoNiCuSn HEA, which confirms that the FeCoNiCuSn forms a single FCC phase, thereby further proving the formation of the FeCoNiCuSn HEA.

Electrocatalytic Performance Test

Electrocatalysis was measured in 1 M KOH using a standard three-electrode system. Using the prepared FeCoNiCuSn high-entropy alloy nano material as a working electrode, a saturated calomel electrode as a reference electrode and a carbon rod as a counter electrode, the test was carried out in an ordinary electrolytic cell. The test was carried out using a Chenhua CHI660E electrochemical workstation. For the hydrogen evolution process, the polarization curve used linear sweep voltammetry, and the sweep voltage ranged from 0 to −0.6 V. For the oxygen evolution process, the sweep voltage ranged from 0 to 0.6 V. The Pt/C electrode and the IrO₂ were purchased from Tianjin Aida Hengsheng Technology Development Co., Ltd. The test method was the same as the above, except that the test was carried out using the 20% Pt/C electrode and the IrO₂ electrode as the working electrode.

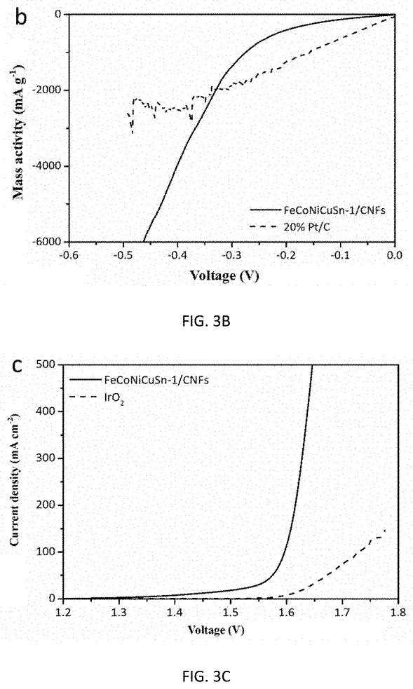

FIG. 3A-3D show electrocatalytic activities of the FeCoNiCuSn HEA/CNFs in an alkaline electrolyte 1 M KOH. FIG. 3A shows a hydrogen evolution area activity curve of the FeCoNiCuSn−1/CNFs and a 20% Pt/C electrode. As can be seen from the figure, the FeCoNiCuSn−1/CNFs electrode needs an overpotential of 65 mV to reach a current density of 10 mA cm⁻², and needs an overpotential of 286 mV to reach a current density of 150 mA cm⁻², and the 20% Pt/C electrode needs an overpotential of 486 mV to reach the same current density of 150 mA cm⁻², which indicates that the performance of the prepared FeCoNiCu-based high-entropy alloy nano material is much better than that of the 20% Pt/C electrode. FIG. 3B shows a hydrogen evolution mass activity curve of the FeCoNiCuSn−1/CNFs and the 20% Pt/C electrode. The mass activity of the FeCoNiCuSn−1/CNFs electrode can reach 6000 mA g⁻¹ under a potential of 466 mV. As can be seen from the figure that under the high voltage of higher than 0.4 V, the current density is significantly better than that of the 20% Pt/C electrode. FIG. 3C shows an oxygen evolution area activity curve of the FeCoNiCuSn−1/CNFs and an IrO₂ electrode. As can be seen from the figure, the FeCoNiCuSn−1/CNFs electrode needs an overpotential of 270 mV to reach a current density of 10 mA cm⁻², and needs an overpotential of 400 mV to reach a current density of 150 mA cm⁻², and the IrO₂ electrode needs an overpotential of 570 mV to reach the current density of 150 mA cm⁻², which indicates that the performance of the prepared FeCoNiCu-based high-entropy alloy nano material is much better than that of the IrO₂ electrode. FIG. 3D shows a oxygen evolution mass activity curve of the FeCoNiCuSn−1/CNFs and the IrO₂ electrode. The mass activity of the FeCoNiCuSn−1/CNFs electrode can reach 1000 mA g⁻¹ under a potential of 370 mV, and under the same voltage, the mass activity of the IrO₂ electrode is only 254 mA g⁻¹, which is much lower than that of the FeCoNiCuSn−1/CNFs.

### Comparative Example 1 Changing Elements

Preparation of MnZnNiCuSn/CNFs Catalytic Material:

(1) 0.1 mmol of manganese chloride, 0.1 mmol of zinc chloride, 0.1 mmol of nickel chloride, 0.1 mmol of cupric chloride, 0.1 mmol of stannic chloride and 0.2 g of dicyandiamide were added to 30 g of polyacrylonitrile/N,N-dimethylformamide solution with a mass fraction of 18 wt %, the mixture was magnetically stirred uniformly, and then the solution was spun by electrospinning to obtain mixed nanofibers. A spinning voltage was controlled to 15 kV, a distance between a receiver and a spinning needle was 15 cm, and a solution flow rate was 0.2 mL/min.

(2) The MnZnNiCuSn/CNFs catalytic material was prepared in the same way as step (2) in Example 1.

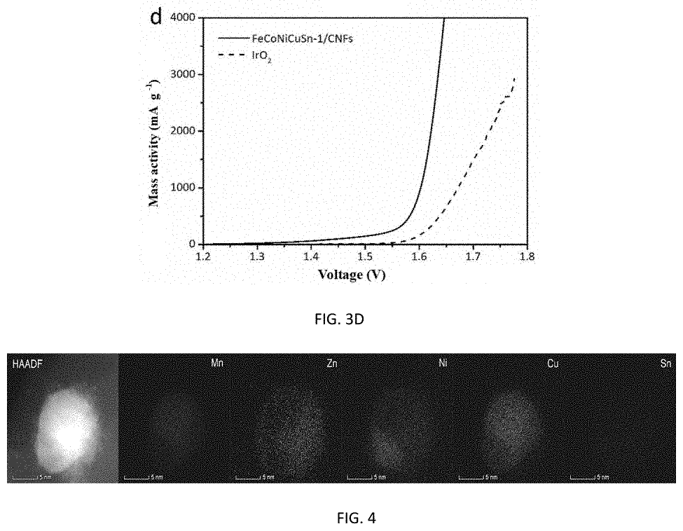

Characterization test: FIG. 4 shows STEM-EDS mapping images of MnZnNiCuSn/CNFs. As can be seen from the figure, elements Mn and Cu are mainly concentrated in the upper right part of the particle, elements Zn and Sn are mainly concentrated in the lower right part of the particle, and element Ni is mainly concentrated in the lower left part of the particle. These elements are not uniformly dispersed in the whole particle, which also indicates that the five elements do not form a uniformly dispersed single phase.

### Comparative Example 2 Changing Heating Rate

Preparation of FeCoNiCuSn-a/CNFs Catalytic Material:

(1) In the same way as step (1) of Example 1.

(2) 0.5 g of the prepared mixed nanofibers was put into a corundum boat, and the corundum boat was placed in the middle of a tube furnace. The temperature was raised to 230° C. at a heating rate of 5° C./min and held for 3 hours in an air atmosphere. After the completion of the holding, carbonization was carried out by raising the temperature to 1000° C. at a rate of 5° C./min in an argon atmosphere and holding the temperature at 1000° C. for 3 hours. After the completion of the holding, the nanofibers were cooled to room temperature under the protection of the argon to obtain the catalytic material, recorded as FeCoNiCuSn-a/CNFs.

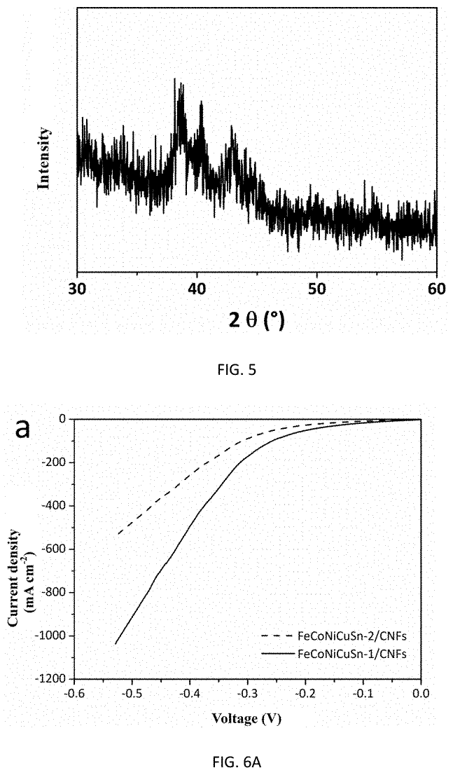

Structural characterization test: The obtained FeCoNiCuSn-a/CNFs catalytic material was subjected to a structural test. FIG. 5 shows an X-ray diffractogram of the FeCoNiCuSn-a/CNFs prepared at the heating rate of 5° C./min. As can be seen from FIG. 5, there are many impure peaks in the X-ray diffractogram, and these peaks are not (111) and (200) crystal planes, which indicates that a high-entropy alloy cannot be formed at a lower heating rate.

### Comparative Example 3 Changing Percentages of Elements

(1) 1 mmol of ferric chloride, 0.3 mmol of cobalt chloride, 0.2 mmol of nickel chloride, 0.6 mmol of cupric chloride, 0.1 mmol of stannic chloride and 0.2 g of dicyandiamide were added to 30 g of polyacrylonitrile/N,N-dimethylformamide solution with a mass fraction of 18 wt %, the mixture was magnetically stirred uniformly, and then the solution was spun by electrospinning to obtain mixed nanofibers. A spinning voltage was controlled to 15 kV, a distance between a receiver and a spinning needle was 15 cm, and a solution flow rate was 0.2 mL/min.

(2) In the same way as step (2) in Example 1, the obtained catalytic material was recorded as FeCoNiCuSn−2/CNFs.

Electrocatalytic test: The electrocatalytic test method was the same as the test method in Example 1.

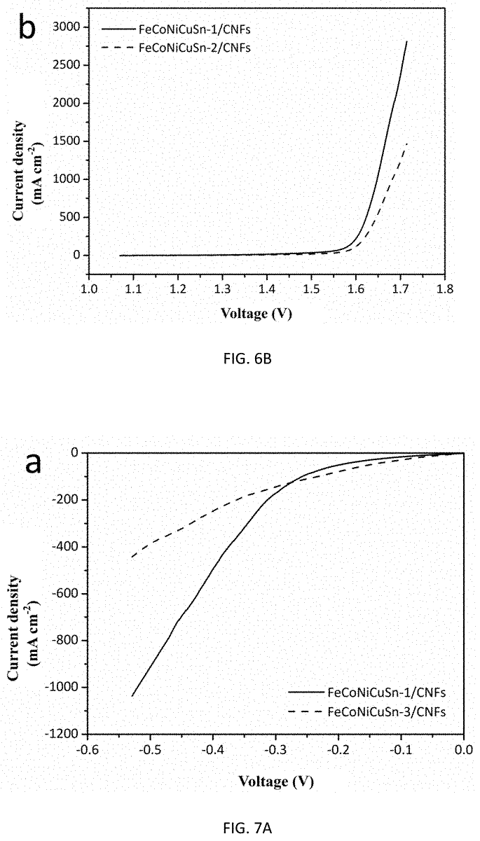

FIG. 6A and FIG. 6B show electrocatalytic activities of FeCoNiCuSn−2/CNFs in an alkaline electrolyte 1 M KOH in Comparative Example 3. FIG. 6A shows a hydrogen evolution area activity curve of the FeCoNiCuSn−2/CNFs. FIG. 6B shows an oxygen evolution area activity curve of the FeCoNiCuSn−2/CNFs. As shown in FIG. 6A, in the hydrogen evolution reaction, to reach a current density of 10 mA cm⁻², the FeCoNiCuSn high-entropy alloy material in Example 1 only needs 65 mV, and the catalytic material prepared in this example needs 110 mV, which indicates that the percentages of elements have a great influence on the hydrogen evolution performance of the alloy material.

For the oxygen evolution reaction, to reach a current density of 10 mA cm⁻², the FeCoNiCuSn high-entropy alloy material in Example 1 only needs 110 mV, and the catalytic material prepared in this example needs 190 mV, which indicates that the percentages of elements also have a great influence on the oxygen evolution performance of the alloy material.

### Comparative Example 4 No Dicyandiamide Added

(1) 1 mmol of ferric chloride, 0.3 mmol of cobalt chloride, 0.2 mmol of nickel chloride, 0.6 mmol of cupric chloride and 0.1 mmol of stannic chloride were added to 30 g of polyacrylonitrile/N,N-dimethylformamide solution with a mass fraction of 18 wt %, the mixture was magnetically stirred uniformly, and then the solution was spun by electrospinning to obtain mixed nanofibers. A spinning voltage was controlled to 15 kV, a distance between a receiver and a spinning needle was 15 cm, and a solution flow rate was 0.2 mL/min.

(2) In the same way as step (2) in Example 1, the obtained catalytic material was recorded as FeCoNiCuSn−3/CNFs.

Electrocatalytic test: The electrocatalytic test method was the same as the test method in Example 1.

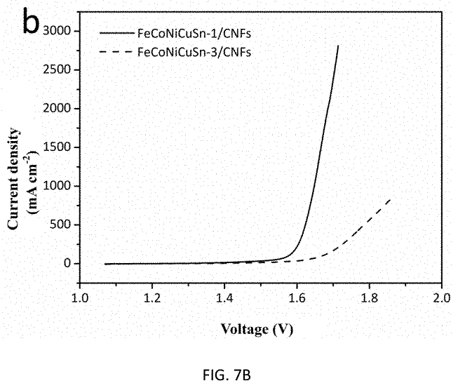

FIG. 7A and FIG. 7B show electrocatalytic activities of FeCoNiCuSn−3/CNFs in an alkaline electrolyte 1 M KOH in Comparative Example 4. FIG. 7A shows a hydrogen evolution area activity curve of the FeCoNiCuSn−3/CNFs. FIG. 7B shows a oxygen evolution area activity curve of the FeCoNiCuSn−3/CNFs. As shown in FIG. 7A, in the hydrogen evolution reaction, to reach a current density of 400 mA cm⁻², the FeCoNiCuSn high-entropy alloy material in Example 1 only needs 375 mV, and the catalytic material prepared in this example needs 507 mV, which indicates that the addition of the dicyandiamide has a great influence on the hydrogen evolution performance of the alloy material.

For the oxygen evolution reaction, to reach a current density of 500 mA cm⁻², the FeCoNiCuSn high-entropy alloy material in Example 1 only needs 390 mV, and the catalytic material prepared in this example needs 540 mV, which indicates that the addition of the dicyandiamide also has a great influence on the oxygen evolution performance of the alloy material.

Although the disclosure herein has been disclosed as above in the preferred examples, it is not intended to limit the disclosure herein. Any person skilled in the art can make various changes and modifications without departing from the spirit and scope of the disclosure herein. Therefore, the protection scope of the disclosure herein should be as defined in the claims.

What is claimed is:

1. A preparation method of a FeCoNiCu-based high-entropy alloy catalytic material for electrolysis of water, comprising the following steps:
(1) preparation of nanofibers comprising four elements of Fe, Co, Ni and Cu and one or more elements of Sn, Mn and V: adding precursors of the elements of Fe, Co, Ni and Cu, a precursor (precursors) of one or more elements of the Sn, Mn and V, and a polymer material into a carbon fiber precursor solution, and stirring the mixture uniformly to obtain a mixed solution; and then spinning the mixed solution by electrospinning to obtain nanofibers comprising four elements of the Fe, Co, Ni and Cu and one or more elements of the Sn, Mn and V; and
(2) preparation of FeCoNiCu-based high-entropy alloy nanoparticle electrocatalytic material: calcining the nanofibers prepared in step (1), and carrying out preoxidation by raising the temperature to 230° C.-280° C. at a heating rate of 10-30° C./min and holding the temperature for 1-3 hours in an air atmosphere; after the completion of the holding, carrying out carbonization by raising the temperature to 800-1200° C. at a rate of 10-30° C./min in an inert gas atmosphere and holding the temperature for 1-3 hours; and after the completion of the holding, cooling the nanofibers to room temperature under the protection of inert gas to obtain the FeCoNiCu-based high-entropy alloy nanoparticle electrocatalytic material.

2. The preparation method according to claim 1, wherein the precursor of the element Fe in step (1) is one or more of ferric chloride, ferric acetate, ferric nitrate and ferric acetylacetonate; the precursor of the element Co is one or more of cobalt chloride, cobalt acetate, cobalt nitrate and cobalt acetylacetonate; the precursor of the element Ni is one or more of nickel chloride, nickel acetate, nickel nitrate and nickel acetylacetonate; the precursor of the element Cu is one or more of cupric chloride, cupric acetate, cupric nitrate and cupric acetylacetonate; the precursor of the element Sn is one or both of stannic chloride and stannic tetraacetate; the precursor of the element Mn is one or more of manganese chloride and manganese acetate; and the precursor of the element V is one or more of vanadium chloride, vanadium acetylacetonate and vanadyl acetylacetonate.

3. The preparation method according to claim 1, wherein a content of each of the four elements of the Fe, Co, Ni and Cu in the nanofibers in step (1) is 5-35 wt %, and a total content of the one or more elements of the Sn, Mn and V is 5-35 wt %.

4. The preparation method according to claim 1, wherein a mole ratio of Fe:Co:Ni:Cu:one or more elements of the Sn, Mn and V in the nanofibers in step (1) is (1-2):(1-4):(1-4):(1-4):(1-4).

5. The preparation method according to claim 1, wherein the polymer material in step (1) is dicyandiamide.

6. The preparation method according to claim 1, wherein the ultrafine carbon fiber precursor in step (1) is any one of polyacrylonitrile, polyvinylpyrrolidone and polyvinyl alcohol, or a mixture of polyacrylonitrile and polyvinylpyrrolidone, and a mass ratio of the polyacrylonitrile to the polyvinylpyrrolidone in the mixture is 1:(0.5-2).

7. The preparation method according to claim 1, wherein conditions of the electrospinning in step (1) are as follows: a spinning voltage is controlled to 10-30 kV, a distance between a receiver and a needle is 15-30 cm, and a solution flow rate is 0.05-0.30 mL/min.

8. The preparation method according to claim 1, wherein the heating rate in step (2) is 20° C./min.

9. The preparation method according to claim 1, wherein an amount of the FeCoNiCu-based high-entropy alloy nanoparticles supported on the carbon nanofibers in step (2) is 2-30 wt %.

10. A FeCoNiCu-based high-entropy alloy catalytic material for electrolysis of water obtained by the method according to claim 1.

11. A method of using the FeCoNiCu-based high-entropy alloy catalytic material of claim 10, comprising carrying out hydrogen production by electrolysis of water using the FeCoNiCu-based high-entropy alloy catalytic material.
